(19) United States
(12) Patent Application Publication
(10) Pub. No.: US 2009/0052060 A1
(43) Pub. Date: Feb. 26, 2009

(54) IMAGING LENS WITH HIGH RESOLUTION AND SHORT OVERALL LENGTH

(75) Inventors: CHUN-LING LIN, Tu-Cheng (TW); CHUN-HSIANG HUANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/948,535

(22) Filed: Nov. 30, 2007

(30) Foreign Application Priority Data
Aug. 22, 2007 (CN) 200710201439.0

(51) Int. Cl. G02B 9/34

(52) U.S. Cl. 359/773

(57) ABSTRACT

An exemplary imaging lens includes, in this order from the object side to the image side thereof, a first lens of positive refraction power, a second lens of negative refraction power, a third lens of positive refraction power, and a fourth lens of negative refraction power. The imaging lens satisfies the formulas of: (1) 0.5<F1/F<1; (2) R6>R5>R7, where F1 is the focal length of the first lens, F is the effective focal length of the imaging lens, R5 is the radius of curvature of the object-side surface of the third lens, R6 is the radius of curvature of the image-side surface of the third lens, and R7 is the radius of curvature of the object-side surface of the fourth lens.

### CROSS-REFERENCE TO RELATED APPLICATION

This application is related to a copending U.S. patent application Ser. No. 11/946311 filed Nov. 28, 2007 (Attorney docket No. US14596) entitled “IMAGING LENS WITH HIGH RESOLUTION AND SHORT OVERALL LENGTH” with the same assignee. The disclosure of the above-identified application is incorporated herein by reference.

### BACKGROUND

1. Technical Field

The invention relates to imaging lenses and, particularly, relates to an imaging lens having a high resolution and a short overall length.

2. Description of Related Art

In order to obtain high image quality, small-sized camera modules for use in thin devices, such as mobile phones, personal digital assistant (PDA), or webcams for personal computers, must have imaging lenses with high resolution but short overall length (the distance between the object-side surface of the imaging lens and the image plane of the camera module). Factors affecting both the resolution and the overall length of the imaging lens, such as, the number and position of lenses employed, the power distribution of the employed lenses, and the shape of each employed lens, complicate any attempt at increasing resolution and shortening overall length of imaging lenses. For example, reducing the number of lenses can shorten the overall length of the imaging lens, but resolution will suffer, conversely, increasing the number of lenses can increase resolution, but increases overall length of the imaging lens.

Therefore, it is desirable to provide an imaging lens which can overcome the abovementioned problems.

### SUMMARY

In a present embodiment, an imaging lens includes, in this order from the object side to the image side thereof, a first lens of positive refraction power, a second lens of negative refraction power, a third lens of positive refraction power, and a fourth lens of negative refraction power. The imaging lens satisfies the formulas of: (1) 0.5<F1/F<1; and (2) R6>R5>R7, where F1 is the focal length of the first lens, F is the effective focal length of the imaging lens, R5 is the radius of curvature of the object-side surface of the third lens, R6 is the radius of curvature of the image-side surface of the third lens, and R7 is the radius of curvature of the object-side surface of the fourth lens.

### BRIEF DESCRIPTION OF THE DRAWINGS

Many aspects of the present imaging lens should be better understood with reference to the following drawings. The components in the drawings are not necessarily drawn to scale, the emphasis instead being placed upon clearly illustrating the principles of the present imaging lens. Moreover, in the drawings, like reference numerals designate corresponding parts throughout the several views.

FIG. 1 is a schematic view of an imaging lens in accordance with an embodiment.

FIG. 2-4 are graphs respectively showing spherical aberration, field curvature, and distortion occurring in the imaging lens in accordance with a first exemplary embodiment.

FIG. 5-7 are graphs respectively showing spherical aberration, field curvature, and distortion occurring in the imaging lens in accordance with a second exemplary embodiment.

FIG. 8-10 are graphs respectively showing spherical aberration, field curvature, and distortion occurring in the imaging lens in accordance with a third exemplary embodiment.

### DETAILED DESCRIPTION OF THE EMBODIMENTS

Embodiments of the present imaging lens will now be described in detail with references to the drawings.

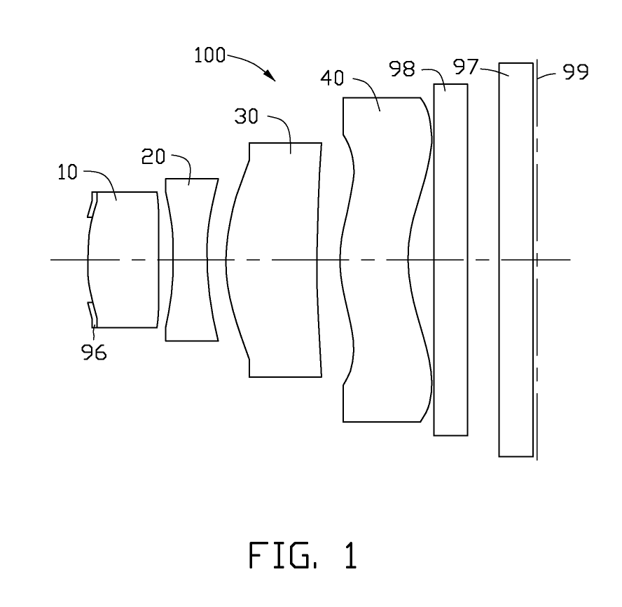

Referring to FIG. 1, the imaging lens 1 00, according to an exemplary embodiment, includes, in this order from the object side to the image side thereof, a first lens 10, a second lens 20, a third lens 30, and a fourth lens 40. The first lens 10 and the third lens 30 have a positive refraction power, while the second lens 20 and the fourth lens 40 have a negative refraction power. The imaging lens 100 satisfies the formulas of: (1) 0.5<F1/F<1; and (2) R6>R5>R7, where F1 is the focal length of the first lens 10, F is the effective focal length of the imaging lens 100, R5 is the radius of curvature of the object-side surface of the third lens 30, R6 is the radius of curvature of the image-side surface of the third lens 30, and R7 is the radius of curvature of the object-side surface of the fourth lens 40.

The formula (1) is used for bounding the refraction power of the first lens 10 to obtain a desirable short overall length of the imaging lens 100 and to control aberrations occurring in the imaging lens 100 within a acceptable level. Specifically, when F1/F<1 is not satisfied, the attempt of shortening the overall length of the imaging lens 100 encounters challenges since, in this case, the rear focal length of the imaging lens 1 00 is too long to get a short overall length of the imaging lens 100, on the other hand, when 0.5<F1/F is not satisfied, aberrations caused by the first lens 10, especially spherical aberration, exceeds the acceptable level. Furthermore, the first lens 10 is advantageously made of glass to prevent from being scratched, and has two spherical surfaces to reduce manufacture cost thereof, accordingly, 0.5<F1/F is also for reducing the radiuses of curvature of the first lens 10 to reduce grinding difficulty of the first lens 10. The formula (2) is adapted for limiting the refraction powers of the third lens 30 and the air lens defined between the third lens 30 and the fourth lens 40 to correct aberrations occurring in the imaging lens 100, especially field curvature and distortion.

Also, the imaging lens 100 satisfies the formula: (3) 0.3<R1/F<0.6, where R1 is the radius of curvature of the object-side surface of the first lens 10. The formula (3) is configured for bounding the radius of curvature of the object-side of the first lens 10 to balance the reduction of the overall length of the imaging lens 100 and the correction of aberrations occurring in the imaging lens 100. Specifically, R1/F<0.6 is for reducing the overall length of the imaging lens 10, especially spherical aberration, within the acceptable level, R1/F>0.3 is for controlling aberrations caused by the first lens 10.

Opportunely, the imaging lens further satisfies the formula: (4) D1>D12, where D1 is the width of the first lens 10 on the optical axis of the imaging lens 100, D12 is the distance between the first lens 10 and the second lens 20 on the optical axis of the imaging lens 100. The formula (2) is used for shortening the air gap between the first lens 10 and the second lens 20 to control the overall length of the imaging lens 100.

More opportunely, the imaging lens 100 also satisfies the formula: (5) 0.3<R7/F<0.6. This formula (5) is for bounding the refraction power of the object-side surface of the fourth lens 40 to befittingly correct aberrations occurring in the imaging lens 100, especially spherical aberration, field curvature, and distortion. Specifically, when R7/F<0.6 is not satisfied, the correction of field curvature may encounter challenges, conversely, when 0.3<R7/F is not satisfied, spherical aberration caused by the first lens 10 may be over corrected.

Specifically, the imaging lens 100 further includes an aperture stop 96. The aperture stop 96 is positioned at the object side of the imaging lens 100 to reduce the size of light flux entering into the imaging lens 100. Namely, the aperture stop 96 is configured for blocking off-axis light rays entering the imaging lens 100 to prevent too much field curvature and distortion occurring in the imaging lens 100, since these off-axis light rays are the main cause of field curvature and distortion. In this embodiment, the aperture stop 96 is a opaque coating on the object-side surface of the first lens 10 to shorten the overall length of the imaging lens 100, and reduce the cost of the imaging lens 100.

In order to correct chromatic aberration occurring in the imaging lens 100, the imaging lens 100 satisfies the formula: (6) V2<35, where V1 is the Abbe number of the first lens 10.

Opportunely and specifically, the three lenses 20, 30, 40 are advantageously made of plastic to reduce the cost of the imaging lens 100, and all have two aspherical surfaces (i.e., the aspherical object-side surface and the aspherical image-side surface) to efficiently correct aberrations. The aspherical surface is shaped according to the formula:

$$x = \frac{{ch}^{2}}{1 + \sqrt{1 - ( k + 1 ) {c}^{2} {h}^{2}}} + \sum {Aih}^{i} ,$$

where h is a height from the optical axis of the imaging lens 100 to the aspherical surface, c is a vertex curvature, k is a conic constant, and Ai are i-th order correction coefficients of the aspheric surfaces.

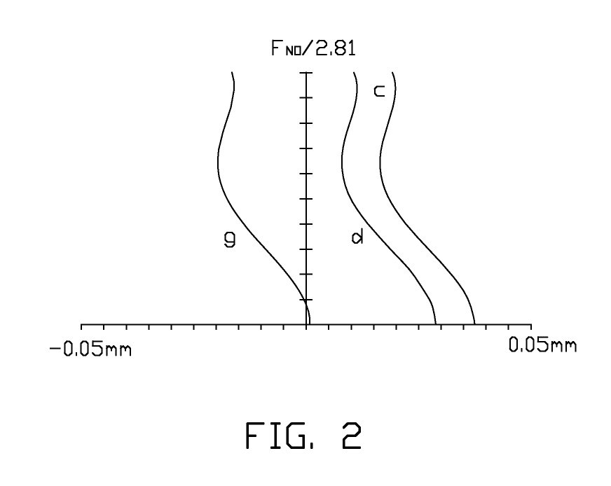

Detailed examples of the imaging lens 100 are given below in company with FIGS. 2-10, but it should be noted that the imaging lens 100 is not limited by these examples. Listed below are the symbols used in these detailed examples:
F_{No}: F number;
2ω: field angle;
R: radius of curvature;
d: distance between surfaces on the optical axis of the imaging lens 100;
Nd: refractive index of lens; and
V: Abbe constant.
   When capturing an image, incident light enters the imaging lens 100, transmits through four lenses 10, 20, 30, 40, an infrared cut filter 98, and a cover glass 97, and finally is focused onto the image plane 99 to form a visual image.

### EXAMPLE 1

Tables 1, 2 show the lens data of Example 1, wherein F=3.92 mm, F_{No}=2.81, and 2ω=62°.

TABLE 1

| Surface | R (mm) | d (mm) | Nd | V |
|---|---|---|---|---|
| Object-side surface of the first | 2.31 | 0.847 | 1.712108 | 47.5931 |
| lens 10 | | | | |
| Image-side surface of the first | −14.247 | 0.17 | — | — |
| lens 10 | | | | |
| Object-side surface of the | −3.366 | 0.4 | 1.6182 | 33.25 |
| second lens 20 | | | | |
| Image-side surface of the | 3.172 | 0.226 | — | — |
| second lens 20 | | | | |
| Object-side surface of the | 2.166 | 1.08 | 1.48749 | 70.4058 |
| third lens 30 | | | | |
| Image-side surface of the | 6.03 | 0.271 | — | — |
| third lens 30 | | | | |
| Object-side surface of the | 1.504 | 0.807 | 1.501886 | 57.8648 |
| fourth lens 40 | | | | |
| Image-side surface of the | 1.69 | 0.303 | — | — |
| fourth lens 40 | | | | |
| Object-side surface of the | infinite | 0.4 | 1.5168 | 64.167336 |
| infrared filter 98 | | | | |
| Image-side surface of the | infinite | 0.38 | — | — |
| infrared filter 98 | | | | |
| Object-side surface of the | infinite | 0.4 | 1.5254 | 62.2 |
| cover glass 97 | | | | |
| Image-side surface of the | infinite | 0.045 | — | — |
| cover glass 97 | | | | |
| Imaging plane 99 | infinite | — | — | — |

TABLE 2

| Surface | Aspherical coefficient |
|---|---|
| Object-side | k = 3.501179; A4 = 0.023559128; A6 = −0.002593523; |
| surface of the | A8 = 0.038117856; A10 = −0.028808062 |
| second lens 20 | |
| Image-side | k = −17.3214; A4 = 0.027675108; A6 = −0.012911835; |
| surface of the | A8 = 0.01197666; A10 = −0.005756877 |
| second lens 20 | |
| Object-side | k = −0.221474; A4 = −0.034887552; A6 = −0.00150474; |
| surface of the | A8 = 0.011051003; A10 = −0.007390695 |
| third lens 30 | |
| Image-side | k = −375.9149; A4 = −0.039205129; |
| surface of the | A6 = 0.027253846; A8 = 0.000321871; |
| third lens 30 | A10 = −0.002197873 |
| Object-side | k = −7.818869; A4 = −0.041467361; |
| surface of the | A6 = −0.023813467; A8 = 0.003913267; |
| fourth lens 40 | A10 = 0.000376873 |
| Image-side | k = −4.057894; A4 = −0.032579818; |
| surface of the | A6 = −0.003090331; A8 = 0.000612299; |
| fourth lens 40 | A10 = −0.000058434 |

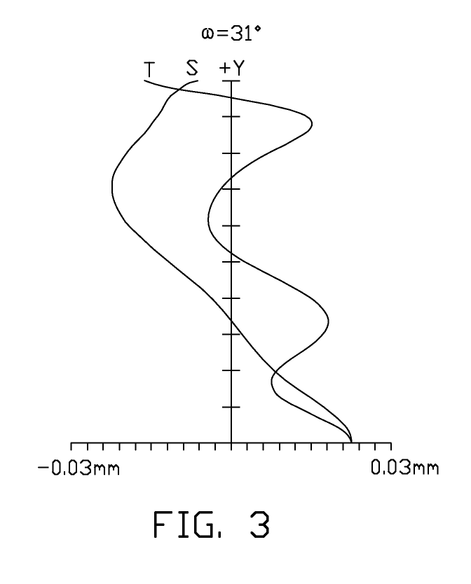

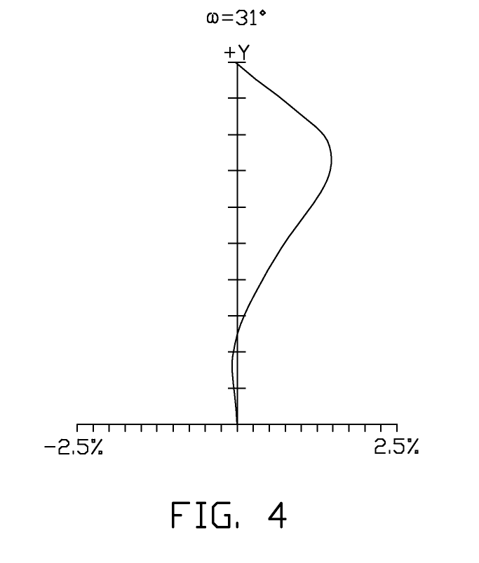

As illustrated in FIG. 2, the curves g, d, and c are respective spherical aberration characteristic curves of g light (wavelength: 435.8 nm), d light (587.6 nm), and c light (656.3 nm) occurring in the imaging lens 100 of Example 1. Obviously, spherical aberration occurring in imaging lens 100 of Example 1 is in a range of: −0.04 mm˜0.04 mm. In FIG. 3, the curves t, s are the tangential field curvature curve and the sagittal field curvature curve respectively. Clearly, field curvature occurring in the imaging lens 100 of Example 1 is limited to a range of: −0.03 mm˜0.03 mm. In FIG. 4, distortion occurring in the imaging lens 100 of Example 1 is limited to be within the range of: −2.5%˜2.5%.

### EXAMPLE 2

Tables 3, 4 show the lens data of EXAMPLE 2, wherein F=4.15 mm, F_{No}=2.81, and 2ω=58.66°.

TABLE 3

| Surface | R (mm) | d (mm) | Nd | V |
|---|---|---|---|---|
| Object-side surface of the | 2.051949 | 0.7893953 | 1.66457 | 1.532955 |
| first lens 10 | | | | |
| Image-side surface of the | −23.80611 | 0.168 | — | — |
| first lens 10 | | | | |
| Object-side surface of the | −4.420939 | 0.412 | 53.007 | 58.7808 |
| second lens 20 | | | | |
| Image-side surface of the | 5.161281 | 0.3882785 | — | — |
| second lens 20 | | | | |
| Object-side surface of the | 2.390057 | 0.9950179 | 1.755201 | 1.5168 |
| third lens 30 | | | | |
| Image-side surface of the | 6.23 | 0.3716246 | — | — |
| third lens 30 | | | | |
| Object-side surface of the | 1.492706 | 0.61 | 27.5795 | 64.167336 |
| fourth lens 40 | | | | |
| Image-side surface of the | 1.210031 | 0.2726837 | — | — |
| fourth lens 40 | | | | |
| Object-side surface of the | infinite | 0.4 | 1.522955 | 1.5254 |
| infrared filter 98 | | | | |
| Image-side surface of the | infinite | 0.4 | — | — |
| infrared filter 98 | | | | |
| Object-side surface of the | infinite | 0.4 | 56.7808 | 62.2 |
| cover glass 97 | | | | |
| Image-side surface of the | infinite | 0.045 | — | — |
| cover glass 97 | | | | |
| Imaging plane 99 | infinite | — | — | — |

TABLE 4

| Surface | Aspherical coefficient |
|---|---|
| Object-side | k = 5.299543; A4 = 0.018697801; A6 = −0.015907763; |
| surface of the | A8 = 0.051188023; A10 = −0.028565258 |
| second lens 20 | |
| Image-side | k = −34.71912; A4 = 0.017099189; A6 = −0.003149201; |
| surface of the | A8 = 0.010375968; A10 = −0.000344777 |
| second lens 20 | |
| Object-side | k = 0.05804339; A4 = −0.031059564; |
| surface of the | A6 = 0.005336067; A8 = −0.000623211; |
| third lens 30 | A10 = −0.001836084 |
| Image-side | k = −507.4565; A4 = −0.029563257; |
| surface of the | A6 = 0.025098551; A8 = −0.004930792; |
| third lens 30 | A10 = 0.000148468 |
| Object-side | k = −10.52922; A4 = −0.11210867; A6 = −0.02505039; |
| surface of the | A8 = 0.009855853; |
| fourth lens 40 | A10 = 0.000250909 |
| Image-side | k = −5.208099; A4 = −0.06355199; |
| surface of the | A6 = 0.00533856; A8 = 0.000412635; |
| fourth lens 40 | A10 = −0.000142026 |

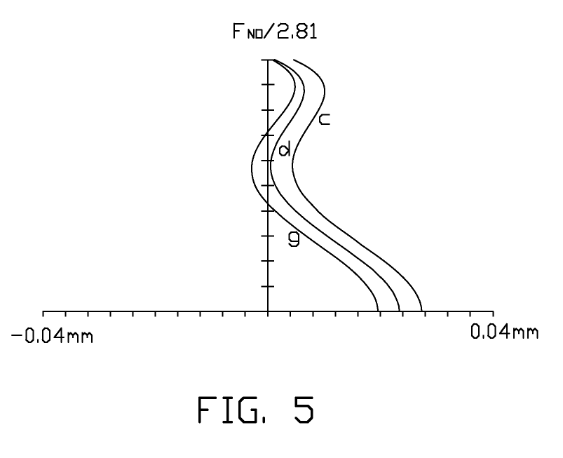

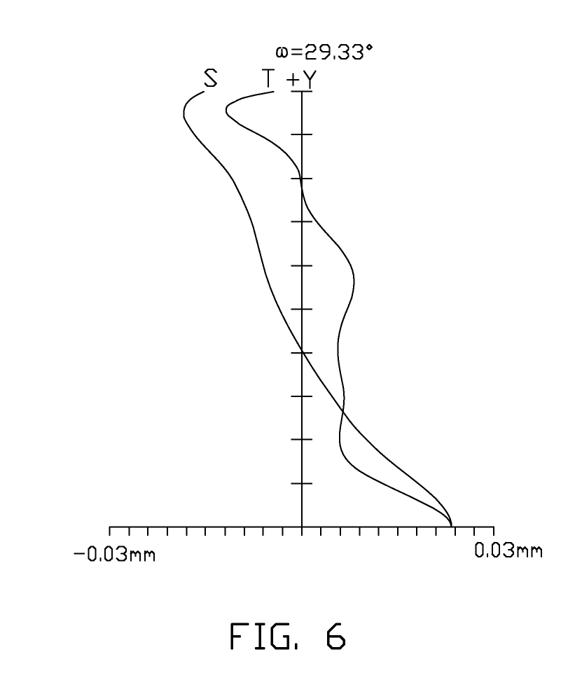

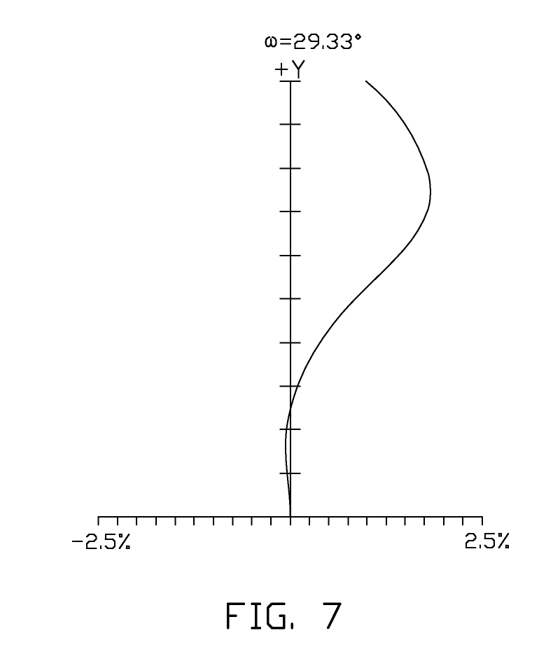

As illustrated in FIG. 5, spherical aberration occurring in imaging lens 100 of Example 2 is in a range of: −0.028 mm˜0.028 mm. As shown in FIG. 6, field curvature occurring in the imaging lens 100 of Example 2 is limited to a range of: −0.03 mm˜0.03 mm. In FIG. 7, distortion occurring in the imaging lens 100 of Example 2 is limited to be within the range of: −2.5%˜2.5%.

Tables 5, 6 show the lens data of EXAMPLE 3, wherein F=4 mm, F_{No}=2.81, and 2ω=59.8°.

TABLE 5

| Surface | R (mm) | d (mm) | Nd | V |
|---|---|---|---|---|
| Object-side surface of the | 2.123546 | 0.78 | 1.623474 | 1.682358 |
| first lens 10 | | | | |
| Image-side surface of the | 28.2113 | 0.33 | — | — |
| first lens 10 | | | | |
| Object-side surface of the | −4.757207 | 0.429 | 59.714 | 59.2779 |
| second lens 20 | | | | |
| Image-side surface of the | 4.240722 | 0.2577253 | — | — |
| second lens 20 | | | | |
| Object-side surface of the | 2.214957 | 0.9263359 | 1.614704 | 1.5168 |
| third lens 30 | | | | |
| Image-side surface of the | 7.789406 | 0.4725472 | — | — |
| third lens 30 | | | | |
| Object-side surface of the | 1.985617 | 0.6493842 | 27.9172 | 64.167336 |
| fourth lens 40 | | | | |
| Image-side surface of the | 1.638365 | 0.2414074 | — | — |
| fourth lens 40 | | | | |
| Object-side surface of the | infinite | 0.4 | 1.611878 | 1.5254 |
| infrared filter 98 | | | | |
| Image-side surface of the | infinite | 0.4 | — | — |
| infrared filter 98 | | | | |
| Object-side surface of the | infinite | 0.4 | 58.9068 | 62.2 |
| cover glass 97 | | | | |
| Image-side surface of the | infinite | 0.045 | — | — |
| cover glass 97 | | | | |
| Imaging plane 99 | infinite | — | — | — |

TABLE 6

| Surface | Aspherical coefficient |
|---|---|
| Object-side | k = 8.14288; A4 = 0.014506305; A6 = −0.017555848; |
| surface of the | A8 = 0.051788575; A10 = −0.023408154 |
| second lens 20 | |
| Image-side | k = −26.61209; A4 = 0.007997176; A6 = −0.007909534; |
| surface of the | A8 = 0.013856641; A10 = −0.000457476 |
| second lens 20 | |
| Object-side | k = 0.1300091; A4 = −0.030413837; |
| surface of the | A6 = 0.005130393; A8 = −0.000676437; |
| third lens 30 | A10 = −0.001037712 |
| Image-side | k = 15.94523; A4 = −0.0313252; |
| surface of the | A6 = 0.026198077; A8 = −0.004926366; |
| third lens 30 | A10 = −0.000691028 |
| Object-side | k = −6.570329; A4 = −0.065912929; |
| surface of the | A6 = −0.029375799; A8 = 0.009638573; |
| fourth lens 40 | A10 = −0.000299699 |
| Image-side | k = −3.750432; A4 = −0.067438119; |
| surface of the | A6 = 0.004515094; A8 = 0.00019677; |
| fourth lens 40 | A10 = 0.00000227 |

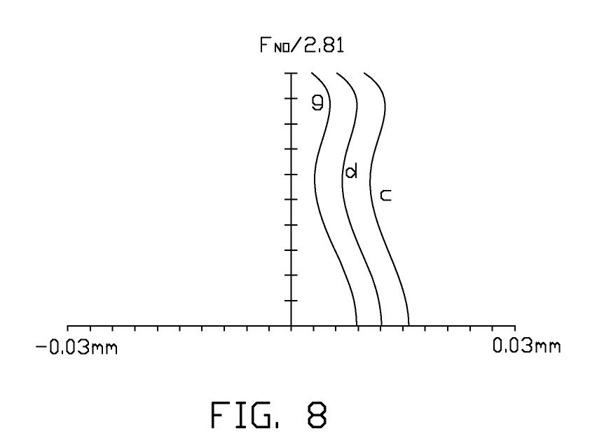

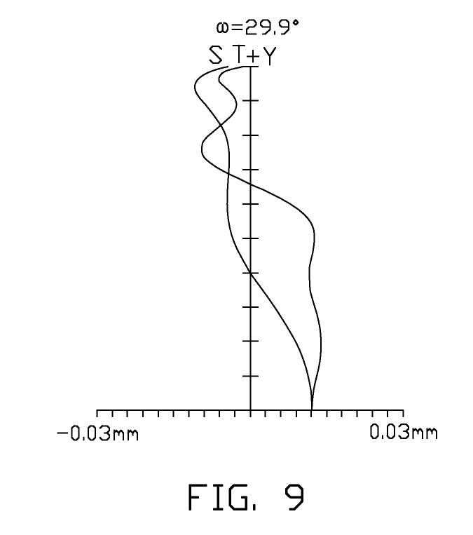

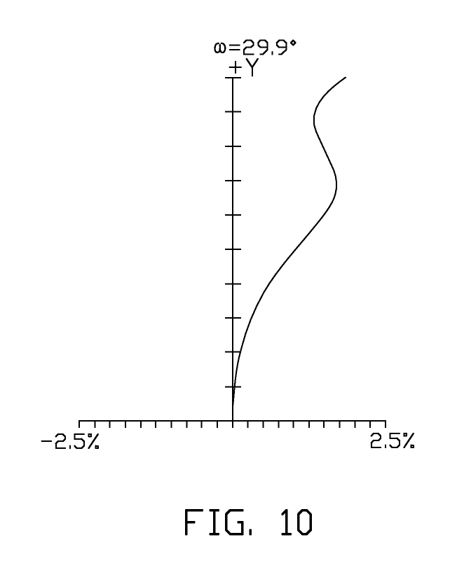

As illustrated in FIG. 8, spherical aberration occurring in imaging lens 100 of Example 2 is in a range of: −0.018 mm˜0.018 mm. As shown in FIG. 9, field curvature occurring in the imaging lens 100 of Example 2 is limited to a range of: −0.03 mm˜0.03 mm. In FIG. 10, distortion occurring in the imaging lens 100 of Example 2 is limited to be within the range of: −2.5%˜2.5%.

In all, in Example 1-3, though the overall length of the imaging lens 100 is reduced, the resolution of the imaging lens 100 is maintained, even improved, since aberrations occurring in the imaging lens 100 are controlled/corrected within an acceptable level.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. An imaging lens comprising, in this order from the object side to the image side thereof, a first lens of positive refraction power, a second lens of negative refraction power, a third lens of positive refraction power, and a fourth lens of negative refraction power; the imaging lens satisfying the formulas of: 0.5<F1/F<1; and R6>R5>R7, where F1 is the focal length of the first lens, F is the effective focal length of the imaging lens, R5 is the radius of curvature of the object-side surface of the third lens, R6 is the radius of curvature of the image-side surface of the third lens, and R7 is the radius of curvature of the object-side surface of the fourth lens.

2. The imaging lens as claimed in claim 1, wherein the first lens is a glass spherical lens.

3. The imaging lens as claimed in claim 1, wherein the imaging lens satisfies the formula: 0.3<R1/F<0.6, where R1 is the radius of curvature of the object-side surface of the first lens.

4. The imaging lens as claimed in claim 1, wherein the imaging lens satisfies the formula D1>D12, where D1 is the width of the first lens on the optical axis of the imaging lens, D12 is the distance between the first lens and the second lens on the optical axis of the imaging lens.

5. The imaging lens as claimed in claim 1, wherein the imaging lens satisfies the formula: 0.3<R7/F<0.6.

6. The imaging lens as claimed in claim 1, wherein the imaging lens comprises an aperture stop, the aperture stop being positioned at the object side of the imaging lens.

7. The imaging lens as claimed in claim 6, wherein the aperture is an opaque coating on the object-side surface of the first lens.

8. The imaging lens as claimed in claim 1, wherein the imaging lens satisfies the formulas of: V2<35, where V2 is the Abbe number of the second lens.

9. The imaging lens as claimed in claim 1, wherein at least one of the second lens, the third lens, and the fourth lens is comprised of plastic material.

10. The imaging lens as claimed in claim 1, wherein the second lens, the third lens, and the fourth lens each have two aspherical surfaces.

11. The imaging lens as claimed in claim 1, wherein the imaging lens comprises an infrared cut color filter, the infrared cut color filter being positioned at the image side of the imaging lens.
